(19) United States
(12) Patent Application Publication
(10) Pub. No.: US 2026/0181675 A1
(43) Pub. Date: Jun. 25, 2026

(54) TRANSMISSION METHOD OF SIDELINK POSITIONING PROTOCOL MESSAGE, APPARATUS, AND COMPUTER-READABLE MEDIUM

(71) Applicant: ZTE CORPORATION, Shenzhen (CN)

(72) Inventors: Yu PAN, Shenzhen (CN); Weiqiang DU, Shenzhen (CN); Chuangxin JIANG, Shenzhen (CN); Mengzhen WANG, Shenzhen (CN); Jing LIU, Shenzhen (CN); Qi YANG, Shenzhen (CN)

(73) Assignee: ZTE CORPORATION, Shenzhen (CN)

(21) Appl. No.: 19/224,079

(22) Filed: May 30, 2025

Related U.S. Application Data
(63) Continuation of application No. PCT/CN2023/075523, filed on Feb. 10, 2023.

(51) Int. Cl. H04W 72/25; H04W 72/543; H04W 72/563

(52) U.S. Cl. CPC H04W 72/25; H04W 72/543; H04W 72/563

(57) ABSTRACT

Wireless communication methods are disclosure. A wireless communication method includes determining, by a user equipment (UE), a configuration of at least one radio bearer of the user equipment for transmitting a SLPP (sidelink positioning protocol) message; and transmitting, by the UE, the SLPP message carried by the at least one radio bearer according to the configuration, where the at least one radio bearer includes at least one of a DRB (data radio bearer) or an SRB (signaling radio bearer).

### TECHNICAL FIELD

This disclosure is generally related to sidelink communication, and more particularly to transmission of sidelink positioning protocol messages.

### BACKGROUND

Wireless communication technologies are pivotal components of the increasingly interconnecting global communication networks. Wireless communications rely on accurately allocated time and frequency resources for transmitting and receiving wireless signals. Sidelink transmission allows two or more pieces of user equipment (UEs) to communicate with each other. SLPP (sidelink positioning protocol) is newly introduced to convey the control signaling of sidelink positioning. However, the mechanism for transmitting the SLPP message is not mature.

### SUMMARY

This summary is a brief description of certain aspects of this disclosure. It is not intended to limit the scope of this disclosure.

According to one or more embodiments of this disclosure, a wireless communication method is disclosed, the method including determining, by a user equipment (UE), a configuration of at least one radio bearer of UE for transmitting a SLPP (sidelink positioning protocol) message; and transmitting, by the UE, the SLPP message carried by the at least one radio bearer according to the configuration, wherein the at least one radio bearer includes at least one of a DRB (data radio bearer) or an SRB (signaling radio bearer).

According to one or more embodiments of this disclosure, another wireless communication method is disclosed, the method including obtaining, by a user equipment (UE), a MAC PDU carrying a SLPP message; and filtering, by a MAC layer of the UE, the MAC PDU based on two different pre-defined conditions to determine whether to send the MAC PDU to an upper layer of the UE.

According to some embodiments of this disclosure, one or more wireless communication methods are further disclosed, the methods include combinations of certain methods, aspects, elements, and steps (either in a generic view or specific view) disclosed in the various embodiments of this disclosure.

Still another embodiment of this disclosure provides a wireless communication apparatus, including a memory storing one or more programs and one or more processors electrically coupled to the memory and configured to execute the one or more programs to perform any method, step, or their combination in this disclosure.

Still another embodiment of this disclosure provides a non-transitory computer-readable storage medium, storing one or more programs, the one or more programs being configured to, when performed by one or more processor, cause to perform any method, step, or their combination in this disclosure.

The above and other aspects and their implementations are described in greater details in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 is a schematic diagram of hardware of a wireless communication apparatus according to an embodiment of the present disclosure;

FIG. 2 is a structural diagram of an apparatus for sidelink communication according to an embodiment of the present disclosure;

FIG. 3 is structural diagram of a communication system according to an embodiment of the present disclosure;

FIGS. 4-5 are schematic diagrams of UEs for sidelink transmission;

FIG. 6 shows an example schematic diagram of the filtering operation of the MAC layer of the receiving UE when the cast type of the UE is set to groupcast or broadcast in the SCI;

FIG. 7 shows an example schematic diagram of the filtering operation of the MAC layer of the receiving UE when the cast type of the UE is set to unicast in the SCI; and

FIGS. 8-9 are schematic diagrams of UEs for sidelink transmission.

### DETAILED DESCRIPTION

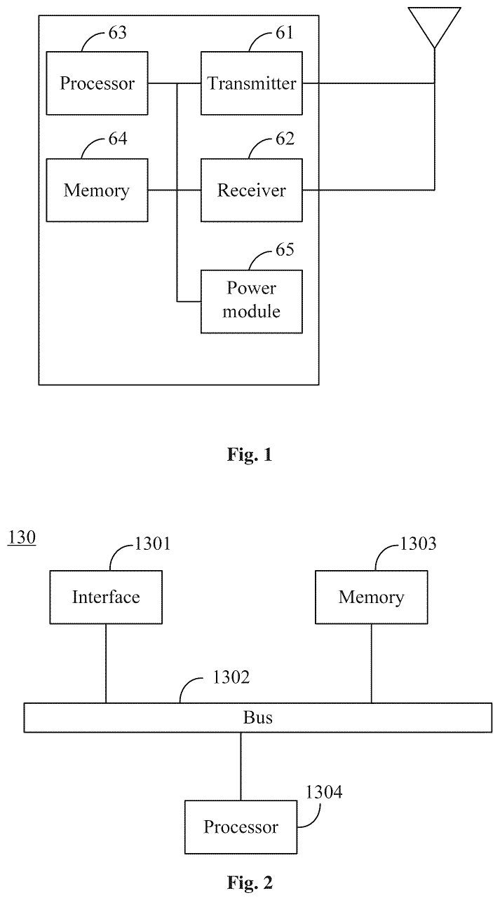

FIG. 1 is schematic diagram of a wireless communication apparatus according to an embodiment of the present disclosure. As shown in FIG. 1, a terminal device may include a mobile terminal such as a mobile phone, a smart phone, a laptop, a digital broadcast receiver, a personal digital assistant (PDA), a PAD, a portable media player (PMP), and a navigation device and a fixed terminal such as a digital television (TV) and a desktop computer. It is assumed that a terminal is the mobile terminal hereinafter. However, those skilled in the art would understand that in addition to elements particularly used for a mobile purpose, a configuration according to an embodiment of the present disclosure can also be applied to a fixed-type terminal.

The terminal device may include a radio communication unit which may specifically be composed of a transmitter 61, a receiver 62, a memory 64, a processor 63, and a power unit 65 in the figure, for example. FIG. 1 illustrates the terminal device with various components. However, it is to be understood that not all the illustrated components are required to be implemented. More or fewer components may be implemented instead. The preceding transmitter may be a physical component of a sending module in the embodiments.

FIG. 2 is a structural diagram of a terminal device for sidelink communication according to an embodiment of the present disclosure. As shown in FIG. 2, a terminal device 130 includes a memory 1303 and a processor 1304. The terminal device 130 may further include an interface 1301 and a bus 1302. The interface 1301, the memory 1303, and the processor 1304 are connected through the bus 1302. The memory 1303 is configured to store one or more instructions or one or more programs. The processor 1304 is configured to read the instructions to perform the technical solutions of the methods or steps as disclosed in this disclosure. The implementation principles and technical effects are similar and not repeated here.

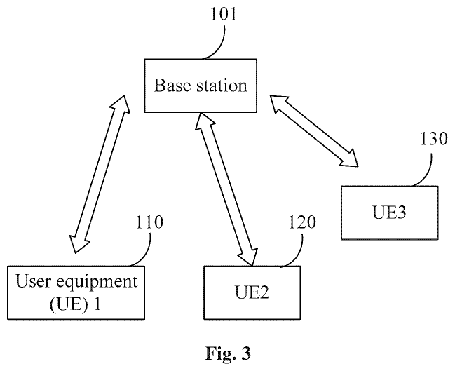

FIG. 3 is structural diagram one of a communication system according to an embodiment of the present disclosure. As shown in FIG. 3, in this embodiment, a description is provided by using an example in which a network side device includes a base station (BS) 101 and a terminal device may include UEs 110, 120, or 130. The preceding BS and UE have the same functions as those in the preceding embodiment and are not repeated here. The devices or systems described above are configured to perform any step or method or their combinations as disclosed in this disclosure.

In sidelink applications, UEs (such as UEs 110, 120, and 130 in FIG. 3) may need to perform sidelink positioning to inform other UEs of its location information. SLPP (sidelink positioning protocol) is introduced to convey the control signaling of sidelink positioning. A SLPP message may carry positioning information of a UE, and it usually has the sidelink (SL) positioning capability, assistance data transfer, and location measurement result transfer. For example, the capability transfer includes the sidelink positioning capability that may be requested from a first UE to another second UE; the sidelink positioning capability of the first UE may be transferred from the first UE to the second UE. The assistance data includes at least one of SL-PRS (sidelink-positioning reference signal) configuration, anchor UE's location information, and other information that facilitates sidelink UE positioning; the assistance data may be transferred between a first UE and a second UE. The measurement report transfer includes transfer of a sidelink positioning measurement results or the sidelink positioning location estimate from a first UE to a second UE. The SLPP message can be generated at a NAS (non-access stratum) layer and transmitted via a PC5 interface between UEs. Further in an AS (access stratum) layer, the SLPP message can be transmitted as a SL-SRB (signaling radio bearer) following a control plane procedure or alternatively as a part of SL-DRB (data radio bearer) following a user plane procedure. To introduce a procedure of the NAS layer and AS layer for transmitting the SLPP message, this disclosure provides, among other things, the association of cast types between NAS layer and AS layer for the SLPP message and detailed solutions on how the SLPP message is transmitted as a conventional SL-SRB, a new SL-SRB, or a dedicated SL-DRB in the AS layer.

According to one or more embodiments of this disclosure, a new SL-SRB can be introduced for SLPP messages, and the upper layer of the UE may indicate the cast type of the SLPP message to the AS layer.

For an SLPP message, a dedicated SL-SRB exclusively for the SLPP message (rather than legacy SL-SRB0˜SL-SRB4) can be introduced in the AS layer. In order to convey the SLPP message, the SL-SRB can be generated at the SLPP layer (or the NAS layer). As mentioned above, the SLPP message may include the capability transfer, assistance data transfer, measurement report transfer. For example, the capability transfer includes the sidelink positioning capability that may be requested from a first UE to another second UE; the sidelink positioning capability of the first UE may be transferred from the first UE to the second UE. The assistance data includes at least one of SL-PRS (sidelink-positioning reference signal) configuration, anchor UE's location information, and other information that facilitates sidelink UE positioning; the assistance data may be transferred between a first UE and a second UE. The measurement report transfer includes transfer of a sidelink positioning measurement results or the sidelink positioning location estimate from a first UE to a second UE.

According to some examples, the SLPP message may support all cast types of transmissions, including broadcast, group cast, and/or, unicast. When delivering the SLPP message from the NAS layer to the AS layer for transmission, the upper layer (e.g., the NAS layer or the SLPP layer) may indicate the cast type of the SLPP message to the lower layer (e.g., the AS layer). Correspondingly, the SL-SRB that is used to convey the SLPP message and is transferred among the AS layer may adopt the cast type as indicated by the NAS layer. The supported cast types include “broadcast and groupcast,” and/or “unicast.” The NAS layer can also indicate the cast type as “broadcast,” “groupcast,” and/or “unicast” to distinguish from the “broadcast” and “groupcast.”

According to some examples, the cast type assigned by the NAS layer may be aligned with the destination Layer 2 (L2) ID, which is also assigned by the NAS layer. According to some example, different cast types correspond to different kinds of destination L 2 ID. When the NAS layer assigns the cast type, the NAS layer may need to ensure that the assigned cast type is aligned with the kind of destination L2 ID as assigned. The mapping between the types of destination L2 ID and cast types can be determined by the NAS layer of the sending UE (Tx UE). The destination L2 ID can identify the target of the data in the sidelink communication. For the sidelink communication, the destination L2 ID can have a length of 24 bits. The destination L2 ID can be split in the MAC layer into two bit strings. One bit string can be the LSB part (16 bits) of Destination L2 ID, and this bit string can be forwarded to the physical layer of the Tx UE. It can identify the target of the intended data in sidelink control information, and it is used for filtering of packets at the physical layer of the Rx UE. A second bit string is the MSB part (8 bits) of the Destination L2 ID, and this part can be carried within the MAC header. It is used for filtering of packets at the MAC layer of the receiver. Source L2 ID can identify the sender of the data in a NR sidelink communication. The Source L2 ID may have a length of 24 bits, and it can be split in the MAC layer into two bit strings. The first bit string is the LSB part (8 bits) of Source L2 ID, and it can be forwarded to the physical layer of the Tx UE. It identifies the source of the intended data in sidelink control information, and it is used to filter the packets at the physical layer of the Rx UE. Second bit string is the MSB part (16 bits) of the Source L2 ID, and the second bit string can be carried within the MAC header. This is used for filtering of packets at the MAC layer of the Rx UE.

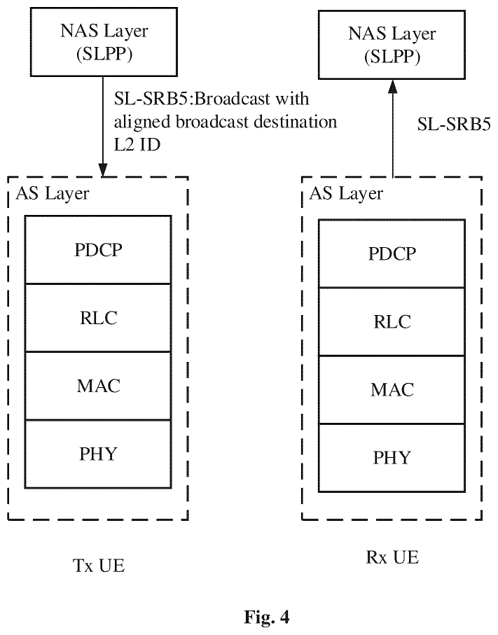

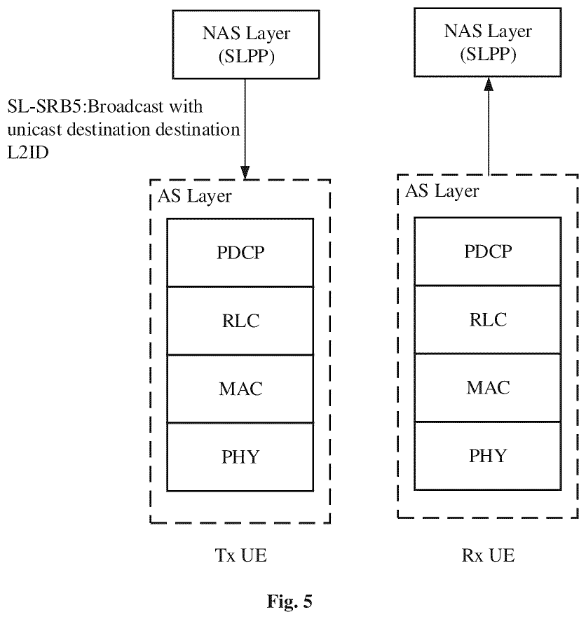

For example as shown in in FIG. 4, a new sidelink signaling radio bearer, SL-SRB5, can be introduced to convey the SLPP message. The cast type of the SLPP message conveyed by the SL-SRB5 can be indicated by the NAS layer as “broadcast.” The destination L2 ID is also set to a broadcast-like destination L2 ID to be aligned. The usage of the SLPP message can be capability transfer, assistance data transfer, or SL-PRS configuration transfer. Then, at the transmitting UE side (Tx UE), the Tx UE's PDCP (Packet Data Convergence Protocol), RLC (Radio link control), MAC (Medium Access Control), and PHY (Physical) layers can take the control of the data or SL-SRB5 or SLPP message according to the broadcast manner in the AS transmission. At receiver side (Rx UE), the Rx UE's PDCP, RLC, MAC, and PHY layers can take the control of the data or SL-SRB5 or SLPP message as broadcast manner as well.

In other examples, the cast type of the SLPP message conveyed by the SL-SRB5 can be indicated by the NAS layer as “unicast.” At the same time, the destination L2 ID is also set to unicast-like destination L2 ID to be aligned, and the usage of the SLPP message can be capability transfer, assistance data transfer, SL-PRS configuration transfer, or location measurement transfer. Then, at the transmitting UE side (Tx UE), the Tx UE's PDCP, RLC, MAC, and PHY layers can take the control of the data/SL-SRB5/SLPP message as unicast manner in the AS transmission. At the receiver side (Rx UE), the Rx UE's PDCP, RLC, MAC, and PHY layers can take the control of the data/SL-SRB5/SLPP message as unicast manner.

Further, if the NAS layer indicates the SL-SRB to be handled in a groupcast or broadcast manner, the Sidelink Control Channel (SCCH) configuration used by the SL-SRB for the SLPP message can be the same as that of the pre-defined SL-SRB0 or SL-SRB4; alternatively, if the NAS layer indicates the SL-SRB to be handled in a unicast manner, the SCCH configuration used by the SL-SRB for the SLPP message can be the same as that of SL-SRB1, SL-SRB2, or SL-SRB3.

According to one or more embodiments of this disclosure, a new SL-SRB can be introduced for transmission of the SLPP message. At transmitting UE side (Tx UE), the AS layer treats all the SLPP message as a presumed cast type agreed upon by the service providers. At the receiver UE side (UE Rx), the MAC layer filters twice according to two different conditions.

For processing the SLPP message, a dedicated SL-SRB-rather than the pre-defined SL-SRB0˜SL-SRB4—can be introduced in the AS layer in order to convey the SLPP message generated at the NAS layer (e.g., the SLPP layer). The SLPP message may include the capability transfer, assistance data transfer, or measurement report transfer.

The SLPP message may support all cast types. The SLPP message generated at the NAS layer (e.g., the SLPP layer) may be broadcasted or groupcasted to multiple receiving UEs or unicasted to one receiving UE according to different destination L2 ID settings of the SLPP message at the NAS layer (e.g., the SLPP layer). However, during the AS layer transmission, the cast type of the SLPP message and its corresponding SL-SRB can be always assumed as one of the “broadcast,” “broadcast and/or groupcast”, or “unicast” cast type by each AS layer (including the PDCP, RLC, MAC, and PHY layers). According to some examples, no cast type can be dynamically indicated by the upper layer; instead, the cast type can be predefined among the service providers. According to some examples, the cast type of the SLPP message and corresponding SL-SRB will not change with time or depending on the SLPP message content. In these examples as shown in FIG. 5, the cast type of the SL-SRB5 containing the SLPP message does not need to align with the destination L2 ID assigned by the upper NAS layer. No matter the destination L2 ID is assigned by the upper layer as broadcast-like, groupcast-like, or unicast-like destination L2 ID, the SLPP message and its corresponding SL-SRB can always be treated or assumed as a single cast type (either broadcast, groupcast, broadcast/groupcast, or unicast) by the PDCP, RLC, MAC, and PHY layers. Further, the SCCH configuration used by the SL-SRB can be the same as SL-SRB0 or SL-SRB4.

As the destination L2 ID is not necessarily aligned with the cast type as it typically does, new approaches to identify the transmission blocks (TB) intended to the specific UE are introduced. According to some embodiments of this disclosure, if the cast type indicator of the SLPP message and/or the cast type indicator of the corresponding SL-SRB is one of “broadcast” or “groupcast” (meaning that, the cast type indicator in the SCI (sidelink control information) that schedules the PSSCH containing the SLPP message is set to “broadcast” or “groupcast”), the receiving MAC layer may firstly determine whether any one of the following conditions is met:
(1) The DST field of the decoded MAC PDU subheader is equal to the 8 MSB (most significant bit) of any of the Destination Layer-2 ID(s) of the UE for which the 16 LSB (least significant bit) are equal to the Destination ID in the corresponding SCI; and
(2) The DST field of the decoded MAC PDU subheader is equal to the 8 MSB of any of the Source Layer-2 ID(s) of the UE for which the 16 LSB are equal to the Destination ID in the corresponding SCI, and the SRC field of the decoded MAC PDU subheader is equal to the 16 MSB of any of the Destination Layer-2 ID(s) of the UE for which the 8 LSB are equal to the Source ID in the corresponding SCI.

The MAC entity of the receiving UE may deliver the decoded MAC PDU (from the received packet) to the disassembly and demultiplexing entity if either one of the above conditions (1) and (2) is satisfied. If the cast type indicator of the SLPP message or the corresponding the SL-SRB is set to one of “broadcast,” “groupcast,” or “broadcast and/or groupcast” in the SCI, the receiving MAC entity may need to filter the received MAC PDU twice according to not only condition (1) but also condition (2). Only if none of the conditions is satisfied, the receiving UE may drop the transmission block (TB) and does not process next step or deliver to a higher layer.

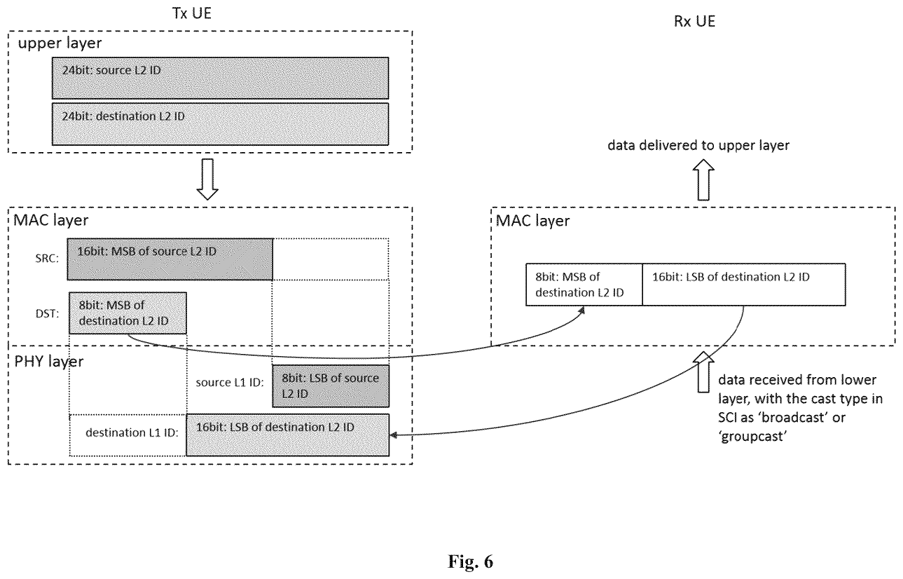

FIG. 6 shows an example schematic diagram of the filtering operation of the MAC layer of the receiving UE when the cast type of the UE is set to groupcast or broadcast in the SCI. Generally, the sending UE (Tx UE) provide a source L2 ID (of 24 bits) and a destination L2 ID (of 24 bits) associated with the SLPP message; the source L2 ID and a destination L2 ID can be assigned by the Tx UE's NAS layer.

On the other hand, the receiving UE (Rx UE) also has a source L2 ID (of 24 bits) and a destination L2 ID (of 24 bits) in order for receiving the TBs. The source L2 ID and the destination L2 ID of the Rx UE can be given by the Rx UE's NAS layer or application layer (a higher layer than the NAS layer). The source L2 ID and the destination L2 ID of the Rx UE are configured independently with source L2 ID and a destination L2 ID of the SLPP message at the Tx UE side.

When sending the TB with the SLPP message, the Tx UE would set an 8 MSB bits of the destination L2 ID in the MAC PDU subheader, and set a 16 bit of the destination L1 ID in the sending SCI. The Tx UE would set 16 MSB bits of the source L2 ID in the MAC PDU subheader, and set an 8 LSB bit of the source L1 ID in the sending DCI.

In condition (1), after the Rx UE receives the TB of the SLPP message, the Rx UE's MAC layer would examine or determine whether the received 8 MSB bits of the destination L2 ID in the MAC PDU subheader is equal to or math the 8 MSB bits of any of the Destination L2 ID(s) of the Rx UE. According to some examples, the prerequisite of the condition (1) includes that: the Rx UE should be the UE where its 16 LSB (least significant bit) destination L2 ID are equal to or match the Destination L1 ID in the corresponding SCI.

In condition (2), after the Rx UE receives the TB of the SLPP message, the Rx UE's MAC entity will examine whether the received 8 MSB bits of the destination L2 ID in the MAC PDU subheader is equal to 8 MSB bits of any of the source L2 ID(s) of the Rx UE and examine whether the received 16 MSB bits of the source L2 ID in the MAC PDU subheader is equal to 16 MSB bits of any of the destination Layer-2 ID(s) of the Rx UE. The prerequisite of the condition 2 is that: the Rx UE should be the UE that its 16 LSB (least significant bit) source L2 ID are equal to the Destination L1 ID in the corresponding SCI, and the Rx UE should be the UE that its 8 LSB of destination L2 ID are equal to the source L1 ID in the corresponding SCI.

According to some embodiments of this disclosure, if the cast type of the SLPP message and/or the corresponding SL-SRB is unicast (for example, when the cast type indicator in the SCI that schedules the PSSCH containing the SLPP message is “unicast”), the receiving MAC entity may need to firstly determine whether either one of the following conditions is met:
(1) The DST field of the decoded MAC PDU subheader is equal to the 8 MSB of any of the Destination Layer-2 ID(s) of the UE for which the 16 LSB are equal to the Destination ID in the corresponding SCI; and
(2) The DST field of the decoded MAC PDU subheader is equal to the 8 MSB of any of the Source Layer-2 ID(s) of the UE for which the 16 LSB are equal to the Destination ID in the corresponding SCI, and the SRC field of the decoded MAC PDU subheader is equal to the 16 MSB of any of the Destination Layer-2 ID(s) of the UE for which the 8 LSB are equal to the Source ID in the corresponding SCI.

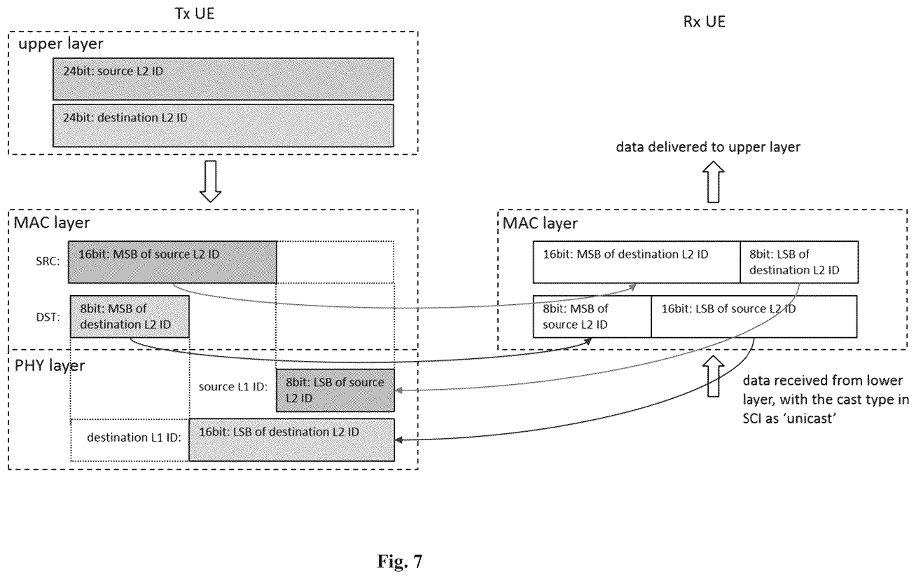

FIG. 7 shows an example schematic diagram of the filtering operation of the MAC layer of the receiving UE when the cast type of the UE is set to unicast in the SCI. The operations under condition (1) and condition (2) have been described above, and would not be repeated again here.

The MAC entity of the receiving UE may deliver the decoded MAC PDU to the disassembly and demultiplexing entity if either one of the conditions (1) or (2) is met. If the cast type indicator of the SLPP message and/or the cast type indicator of the corresponding SL-SRB is set to “unicast” in the SCI, the receiving MAC entity of the receiving UE may need to filter the decode MAC PDU twice to determine not only condition (2) but also condition (1) is met. Alternatively, if none of the conditions (1) and (2) is satisfied, the receiving UE may drop the TB (transmission block) and does not process the next step or deliver to a higher layer as the receiving UE determines that the received TB is not intended for the receiving UE.

Table 1 below shows the filter conditions used to identify the TBs received by the intended destination in different SCI indicators and destination L2 IDs. For example, when the SCI indicates the TB is transmitted under a broadcast cast type, the receiving UE may use condition (1) above when the destination L2 ID is a broadcast destination L2 ID. The receiving UE may use condition (1) above when the destination L2 ID is a groupcast destination L2 ID. The receiving UE may need to use both conditions (1) and (2) above when the destination L2 ID is a unicast destination L2 ID, meaning that if either one of the conditions (1) and (2) is met, the MAC layer of the receiving UE would provide the MAC PDU to further processing.

TABLE 1

| | Broadcast | Groupcast | Unicast |
|---|---|---|---|
| | destination | destination | destination |
| | L2 ID | L2 ID | L2 ID |
| Broadcast in SCI | Condition 1 | Condition 1 | Filter twice (conditions |
| | | | 1 and 2) |
| Groupcast in SCI | Condition 1 | Condition 1 | Filter twice (conditions |
| | | | 1 and 2) |
| Broadcast/Groupcast | Condition 1 | Condition 1 | Filter twice (conditions |
| in SCI | | | 1 and 2) |
| Unicast | Filter twice | Filter twice | Condition 2 |
| in SCI | (condition 1 and 2) | (condition 1 and 2) | |

According to some embodiments of this disclosure, the SCI may contain a new cast type indicator (other than the legacy broadcast, groupcast, and unicast), and this cast type indicator is dedicated for a SLPP message. If the new cast type indicator in the SCI is received, the receiving UE's MAC will read the new cast type indicator in SCI and perform twice the filtering based on conditions (1) and (2) above. The MAC of the receiving UE may provide the MAC PDU to the upper layer when either one of the conditions (1) or (2) is met.

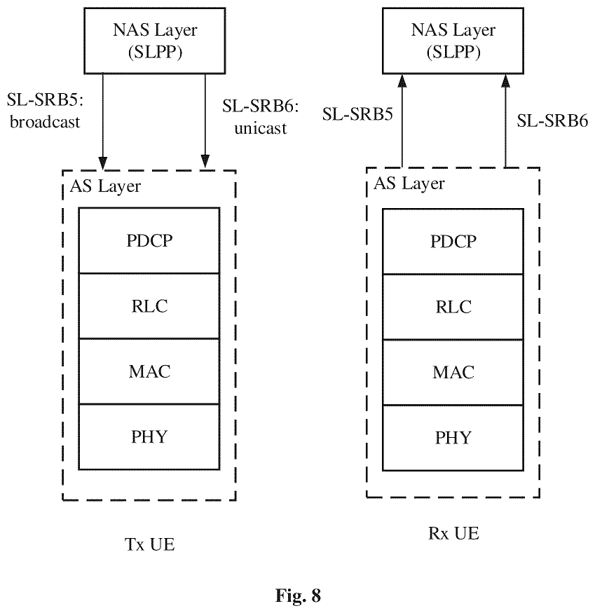

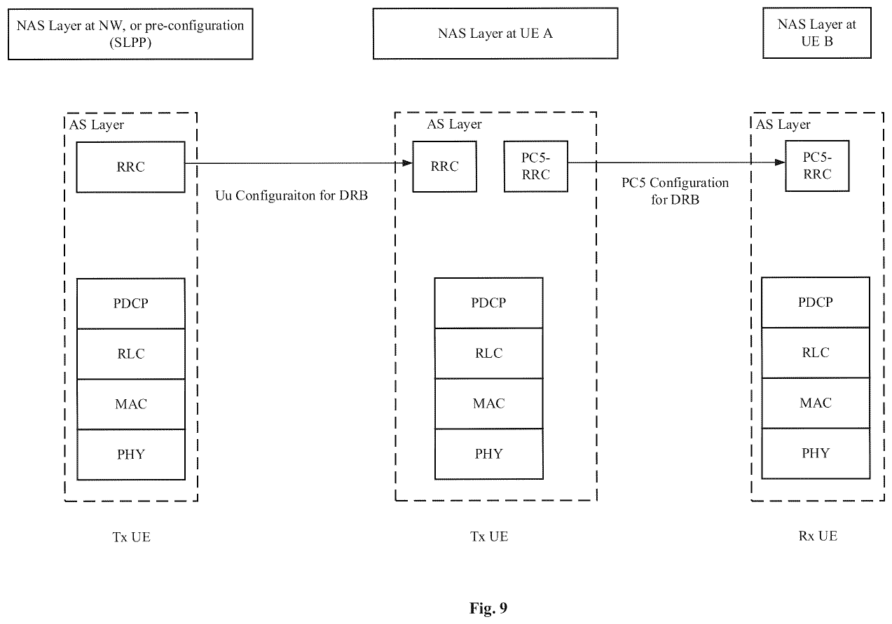

According to some embodiments of this disclosure as shown in FIG. 8, two dedicated SL-SRBs can be introduced for the SLPP messages. Optionally, one of the new SL-SRBs can be used to convey broadcast or groupcast SLPP messages; the other SL-SRB can be used to convey unicast SLPP messages.

According to some examples, the two dedicated SL-SRBs (optionally, rather than SL-SRB0˜SL-SRB4) may be introduced in the AS layer in order to convey the SLPP message generated at the SLPP layer (the NAS layer). The SLPP message may include the capability transfer, assistance data transfer, or measurement report transfer.

Between the two SL-SRBs, one SL-SRB (e.g., SL-SRB5) can be used to convey the broadcast and/or groupcast SLPP messages; the other SL-SRB (e.g., SL-SRB6) can be used to convey unicast SLPP messages. The mapping of SL-SRBs and the corresponding cast type can be predefined by the service providers. For example, SL-SRB5 can be used for broadcast and/or groupcast SLPP messages, and SL-SRB6 can be used for unicast SLPP message delivery.

Additionally or alternatively, the SCCH configuration used by the broadcast or groupcast SL-SRB can be the same as the SCCH configuration of SL-SRB0 or SL-SRB4. The SCCH configuration used by the unicast SL-SRB can be the same as that of either SL-SRB1, SL-SRB2, or SL-SRB3.

According to some embodiments of this disclosure, the SLPP message can be conveyed by any one of SL-SRB0 to SL-SRB4.

According to some example, different SRBs are used to convey different kinds of control signaling. For example, one sidelink SRB (e.g., SL-SRB0) is used to transmit the PC5-S messages before the PC5-S security has been established, where the sidelink transmission can be broadcast or groupcast. Alternatively, another sidelink SRB (e.g., SL-SRB1) can be used to transmit the PC5-S messages to establish the PC5-S security, where the sideline transmission is unicast. Alternatively, one sidelink SRB (e.g., SL-SRB2) can be used to transmit the PC5-S messages after the PC5-S security has been established, where the transmission is protected and of a cast type of unicast. Alternatively, one sidelink SRB (e.g., SL-SRB3) can be used to transmit the PC5-RRC signalling, where the transmission is protected and only sent after the PC5-S security has been established, and where the transmission is of a cast type of unicast.

According to some examples, SL-SRB0 or SL-SRB4 can be used to convey the broadcast and/or groupcast SLPP messages; SL-SRB1, SL-SRB2 or SL-SRB3 can be used to convey unicast SLPP messages. In these examples, the SLPP messages is multiplexed with the original messages in the SL-SRB0/1/2/3/4. Alternatively or additionally, the SL-SRB0/1/2/3/4 is used to transmit SLPP messages at a certain period, and at other times, the same SL-SRB0/1/2/3/4 can be used for transmitting the original message other than the SLPP messages. In the AS layer transmission according to these examples, the cast type of the SLPP messages may follow the cast type of the SL-SRB used to convey the SLPP message. Similarly in the AS layer transmission according to these examples, the transmission setting of the SLPP messages may follow the transmission setting of the SL-SRB used to convey the SLPP message.

Further, the SL-SRB may be indicated that whether the current SL-SRB is used to transmit (or multiplexed with) SLPP messages or not. An indication may be added in the SCCH configuration, i.e., each SL-SRB configuration/format. For example, the NAS layer may indicate whether a SL-SRB is used to transmitted or multiplexed with SLPP messages.

According to some embodiments, the operation of the different layers for transmission of the SLPP message is describe as follows.

PDCP at the Tx UE. When the Tx UE's PDCP layer receives the PDCP SDU from the upper layer, each received SL-SRB may be associated with a PDCP entity. According to some embodiments, the PDCP layer knows the cast type of current SLPP message and/or its associated SL-SRB(s).

For the SLPP message (received from upper layer) and/or the associated SL-SRB, the Tx UE's PDCP layer may determine whether ciphering and/or integrity protection should be performed on the SL-SRB or may determine the PDCP data PDU format for the SL-SRB. For the transmitting PDCP entity, the PDCP layer may determine whether ciphering and/or integrity protection should be performed to the SL-SRB. For example, if the SL-SRB is a unicast SL-SRB, the ciphering and/or integrity protection may be performed. If the SL-SRB is a broadcast SL-SRB and or a groupcast SL-SRB, the ciphering and/or integrity protection may not be performed.

The Tx UE's PDCP layer may also determine the PDCP data's PDU format for the SL-SRB. It should be noted that the PDCP PDU format can be applied for both transmission PDCP entities and receiving PDCP entities. For example, if the SL-SRB is a broadcast or groupcast SL-SRB, the data PDU format for sidelink DRBs for groupcast and broadcast and for the sidelink SL-SRB0 and for the sidelink SL-SRB4 should be applied to the SL-SRB. Alternatively, if the SL-SRB is a unicast SL-SRB, the data PDU format for sidelink SL-SRBs for unicast may be applied to the SL-SRB.

RLC at the Tx UE. After the PDCP layer, the PDCP PDU corresponding to the SL-SRB (which contains the SLPP message) will become the input of RLC layer. The RLC layer may determine the UM (Unacknowledged Mode) RLC mode or AM (Acknowledged Mode) RLC mode according to the cast type of the SLPP message/PDCP PDU/RLC SDU/SL-SRB. In some examples, if the SLPP message is broadcast or groupcast, only the UM mode is applied.

Additionally or alternatively, the RLC determines the RLC PDU of different AM, UM or TM mode. In some examples, the broadcast/groupcast SLPP message may use a UMD (unacknowledged mode data) PDU with 6 or 12 bit SN (sequence number). The unicast SLPP message should use an AMD (acknowledged mode data) PDU with 12 bit or 18 bit SN. It should be noted that the RLC PDU format can be applied for both transmitting RLC entities and receiving RLC entities. The output of RLC layer is RLC PDU.

MAC at the Tx UE. Afterwards, the RLC PDUs will become the input of the MAC layer, and the MAC layer may handle the RLC PDUs. The MAC layer may determine the source L2 ID, destination L2 ID, and the cast type of the SLPP message, for example, according to the indication of the upper layer. A new LCID may be introduced for the SLPP message, for example, value 20. Table 2 below shows an example list of LCID with the newly introduce LCID.

TABLE 2

| Index | LCID values |
|---|---|
| 0 | SCCH carrying PC5-S messages that are not protected |
| 1 | SCCH carrying PC5-S messages “Direct Security Mode |
| | Command” and “Direct Security Mode Complete” |
| 2 | SCCH carrying other PC5-S messages that are protected |
| 3 | SCCH carrying PC5-RRC messages |
| 4-19 | Identity of the logical channel |
| 20 | SCCH for SLPP messages |
| 21-55 | Reserved |
| 56 | SCCH carrying RRC messages delivered via SL-RLC0 |
| 57 | SCCH carrying RRC message delivered via SL-RLC1 |
| 58 | SCCH for Sidelink Discovery Messages |
| 59 | Sidelink Inter-UE Coordination Request |
| 60 | Sidelink Inter-UE Coordination Information |
| 61 | Sidelink DRX Command |
| 62 | Sidelink CSI Reporting |
| 63 | Padding |

PHY layer at the Tx UE. The cast type, source L1 ID, and destination L1 ID can be set in a 2-stage SCI by the UE according to the MAC layer's indication. Then, the Physical Sidelink Control Channel (PSCCH), which contains the SCI, and the corresponding Physical Sidelink Shared Channel (PSSCH), which contains the scheduled data by the SCI with the SLPP message, will be transmitted to the other UEs in PC5 interface.

PHY layer at the Rx UE. The Rx UE receives the SCI and the corresponding PSSCH containing the SLPP message, and then the Rx UE delivers the received material to the upper layer.

MAC layer at the Rx UE. According to the different cast types (e.g., broadcast/groupcast, or unicast) indicated in the SCI, the Rx UE's MAC layer decodes the LCID and filters the destination L2 ID and/or source L2 ID, adopting the corresponding filter rules (e.g., condition (1) and condition (2) described above). If the MAC layer verifies that the received TB is intended for the current UE, the TB will be further processed and finally be delivered to the upper layer.

RLC at the Rx UE. If the SLPP message is a groupcast or broadcast SLPP message, when setting the parameter RX_Next_Reassembly, the Rx UM RLC entity may set the SN of the first received UMD PDU containing an SN. When setting the parameter RX_Next_Highest, the Rx UM RLC entity may set to the SN of the first received UMD PDU containing an SN.

PDCP at the Rx UE. The PDCP layer of the Rx UE may determine whether to send the PDCP SDU to the upper layer with an indication. Specifically, for reception of the SL-SRB, the PDCP layer of the Rx UE may send the corresponding PDCP SDU to the upper later with an indication which indicates that the PDCP PDU is a PC5-S message, a sidelink discovery message, or an SLPP message. The PDCP layer of the Rx UE may determine whether decipher and/or integrity verification should be performed to the SL-SRB. Regarding to the RX_NEXT, for broadcast or groupcast SLPP message, the initial value of the SN part of RX_NEXT is (x+1) modulo (2^{[sl-PDCP-SN-Size]}), where x is the SN of the first received PDCP Data PDU. Regarding to the RX_DELIV, the initial value of the SN part of RX_DELIV is (x−0.5×2[sl-PDCP-SN-Size−1]) modulo (2[sl-PDCP-SN-Size]), where x is the SN of the first received PDCP Data PDU.

According to some embodiments of this disclosure, a priority indicator may be introduced to indicating the SLPP message for a higher priority. An indication can be introduced to identify a user date bearer that contains SLPP messages.

According to some examples, the SLPP message can be conveyed by a user plane to send to one or more UEs. The signaling flow in the Tx UE is sequentially the NAS layer (SLPP layer), the SDAP layer, the PDCP layer, the RLC layer, the MAC layer, and the PHY layer. After the Rx UE receives the SLPP message contained in the PSSCH at the PHY layer, the signaling flow in the Rx UE is sequentially the PHY layer, the MAC layer, the RLC layer, the PDCP layer, the SDAP layer, and the NAS layer (SLPP layer).

The usage of SDAP layer is to map one or more PC5 QoS flows onto one SL-DRB. One PC5 QoS flow is mapped onto only one SL-DRB at a time in the NR sidelink for transmission. Multiple PC5 QoS flows can be mapped onto one SL-DRB.

The user data transmission way in the AS layer (including the SDAP, PDCP, RLC, MAC, and PHY) of the Tx UE to the Rx UE is configured by the core network to the Tx UE, via a Uu RRC signaling, a pre-configuration signaling, or PC5 RRC signaling.

In Uu RRC configuration or pre-configuration, each QoS flow can be associated with a corresponding QoS profile and a QoS flow ID (up to 2048 per UE). The QoS profile has standard QoS PQI (up to 255) and non-standard PQI (PC5 QoS Identity), and the QoS profile includes the priority (with a value from 1-8) of the corresponding QoS flow. Multiple QoS profiles can be mapped to a SL-DRB, and the multiple QoS profiles may have a signal cast type as configured in SL-SDAP configuration, meaning that one SL-DRB may have one cast type. In PC5-RRC configuration, UE A indicates that a specific number (up to 64) of QoS flows having the same destination are mapped to a SL-DRB. FIG. 7 shows an example structure of Uu RRC signaling, pre-configuration, and PC5-RRC signaling for SL-DRB configuration.

There can be two kinds of priority for SL-DRBs.

QoS flow priority. If the priority level of the QoS flow priority is not presented in the PC5 QoS profile, the default values would apply. The priority indication can be provided via a default PQI to the QoS characteristics mapping. According to some examples, the lower packet delay budget is, the lower number of priority value is. Here, a lower number means a higher priority. Alternatively, a PQI may be used together with an application indicated priority, which may override the default priority level of the PQI.

Logical channel priority. The logic channel priority may be included in the SL-LogicalChannelConfig parameter to indicate the priority of a logical channel used to transmit a SLPP message. If SLPP message generated at NAS layer is multiplexed with the user data, the SDAP layer will also map the QoS flow that contains the SLPP message to SL-DRB. There are several ways to for ensuring the SLPP message containing in the user data will have the higher priority.

An identification dedicated for the PC5 QoS flow(s) or SL-DRB(s), which indicates whether the PC5 QoS flow(s) or SL-DRB(s) contains the SLPP message or not can be introduced, such that the NAS layer may notify the lower layer that the QoS flow(s) containing SLPP message as differentiated from other QoS flows. The lower layer may assign a different priority level for the SL-DRBs containing SLPP messages from other SL-DRBs without SLPP messages. Further, the identification may come from a NAS layer to an AS layer. For example, the identification can be indicated in the SL-QoS-Profile or in sl-PQI. Alternatively, the identification can be indicated in the PQI value. Thereby, some of the PC5 QoS flows containing SLPP messages are treated differently. The identification can be contained in SL-SDAP-Config or SL-RadioBearerConfig parameters in RRC signaling or pre-configuration. The identification can also be contained in SL-SDAP-ConfigPC5 or slrb-Config parameters in PC5-RRC singaling. As an example, the identification can be a Boolean value.

For the QoS flows that contain SLPP messages, a new QoS flow to SL-DRB mapping rule can be introduced in at least one of RRC signaling, pre-configuration, or PC5-RRC signaling. The SDAP layer can map the QoS flow(s) containing the SLPP messages to one or more dedicated SL-DRB(s) according to the upper layer indication. The new mapping rule of QoS flow to SL-DRB can be configured in SL-SDAP-Config or SL-SDAP-ConfigPC5 signalings.

Alternatively or additionally, for the SL-DRBs or the PC5 QoS flows that contain SLPP message, the SL-DRBs should be mapped to the highest logical channel priority (same as the priority of SCCH, the value of logical channel priority is 1). Further, the mapping can be configured in SL-RLC-BearerConfig.

Alternatively or additionally, the NAS layer maps the SLPP messages into the highest priority user data packet (e.g., the QoS flow having the priority index equal to 1). Furthermore, the SLPP message and the highest priority user data packets may have the same source L2 ID, destination L2 ID, and cast type.

Alternatively or additionally, a priority indication for SL-DRBs can be introduced. An IE (information element) in the SL-SDAP-Config, SL-SDAP-ConfigPC5, SL-RadioBearerConfig, or slrb-Config can be introduced to indicate the priority level of the corresponding SL-DRBs. For example, the priority level value can choose from {1,2,3,4,5,6,7,8}, wherein 1 indicates the highest priority. Further, among all the SL-DRBs, the one or more SL-DRBs that contain SLPP messages can be assigned with highest priority value.

Alternatively or additionally, the PDCP layer can be indicated by RRC signaling, pre-configuration signaling, or PC5-RRC singaling to map the QoS flow containing the SLPP messages into the default SL-DRB of one destination. Further, the default SL-DRB containing the SLPP messages can be assigned with the highest logical channel priority or SL-DRB priority.

According to some embodiments of this disclosure, a wireless communication method is provided. The method includes determining, by a user equipment (UE), a configuration of at least one radio bearer of the UE for transmitting a SLPP (sidelink positioning protocol) message; and transmitting, by the UE, the SLPP message carried by the at least one radio bearer according to the configuration, wherein the at least one radio bearer comprises at least one of a DRB (data radio bearer) or an SRB (signaling radio bearer).

According to some exemplary implementations of various embodiments, the SRB is exclusively for carrying the SLPP message.

According to some exemplary implementation of various embodiments, the wireless communication method further includes comprising determining, by the UE, a LCID (logical channel identity) dedicated for the SRB.

According to some exemplary implementations of various embodiments, the configuration of at least one radio bearer includes a cast type indication of the SLPP message from a NAS layer of the UE to a AS layer of the UE.

According to some exemplary implementations of various embodiments, the cast type indication indicates at least one of unicast, groupcast, or broadcast.

According to some exemplary implementations of various embodiments, the wireless communication methods further includes transmitting, by the UE, the SLPP message carried by the SRB according to the configuration, wherein the configuration comprises a predefined cast type of the SRB.

According to some exemplary implementations of various embodiments, the wireless communication methods further includes transmitting, by the UE, the SLPP message carried by two SRBs according to the configuration. The configuration comprises a predefined cast type of each of the two SRBs. The predefined cast type of one SRB within the two SRBs is at least one of broadcast or groupcast, and the predefined cast type of the other SRB within the two SRBs is unicast.

According to some exemplary implementations of various embodiments, the at least one SRB corresponding to the at least one radio bearer is at least one of SL-SRB0, SL-SRB1, SL-SRB2, SL-SRB3 or SL-SRB4.

According to some exemplary implementations of various embodiments, the wireless communication method further includes transmitting, by an AS layer of the UE to a NAS layer of the UE, a first indication to indicate whether the at least one SRB is used to transmit the SLPP message.

According to some exemplary implementations of various embodiments, the first indication is indicated in a sidelink control channel configuration.

According to some exemplary implementations of various embodiments, each of the at least one SRB corresponding to each of the at least one radio bearer has different SRB type.

According to some exemplary implementations of various embodiments, the radio bearer includes the at least one DRB and the configuration includes a second indication to indicate whether the at least one DRB contains the SLPP message.

According to some exemplary implementations of various embodiments, the radio bearer includes the at least one DRB and the configuration includes a third indication to indicate whether a QoS flow corresponding to the DRB contains the SLPP message.

According to some exemplary implementations of various embodiments, the radio bearer includes the at least one DRB and the configuration comprises a forth indication to indicate a priority of the DRB.

According to some exemplary implementations of various embodiments, the radio bearer includes the at least one DRB and the configuration comprises a QoS flow-to-DRB mapping rule of a QoS flow that contains the SLPP message.

According to some exemplary implementations of various embodiments, the configuration includes a priority of a logical channel of the DRB or a priority of a QoS flow of the SLPP message, wherein the priority of the logical channel of the DRB or the priority of the QoS flow of the SLPP message is of a highest priority.

According to some embodiments of this disclosure, a wireless communication method is disclosed. The method includes: obtaining, by a user equipment (UE), a MAC PDU carrying a SLPP message; and filtering, by a MAC layer of the UE, the MAC PDU based on two different pre-defined conditions to determine whether to send the MAC PDU to a disassembly and demultiplexing entity.

According to some exemplary implementations of various embodiments, filtering the MAC PDU includes determining at least one of the following two predefined conditions: (1) a DST field of a decoded MAC PDU subheader is equal to 8 MSB of any of Destination Layer-2 ID(s) of the UE, wherein 16 LSB of the Destination Layer-2 ID(s) of the UE are equal to a Destination ID in a corresponding SCI sidelink control information (SCI); or (2) a DST field of a decoded MAC PDU subheader is equal to 8 MSB of any of Source Layer-2 ID(s) of the UE, wherein 16 LSB of the Source Layer-2 ID(s) of the UE are equal to a Destination ID in a corresponding SCI, and a SRC field of the decoded MAC PDU subheader is equal to 16 MSB of any of the Destination Layer-2 ID(s) of the UE, wherein 8 LSB of the Destination Layer-2 ID(s) of the UE are equal to a Source ID in a corresponding SCI.

According to some embodiments of this disclosure, various wireless communication methods are disclosed. The wireless communication methods include any possible combinations of selections of any disclosed step, element, or method, aspect, and their generic derivative in this disclosure.

Various exemplary embodiments of the present disclosure are described herein with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

The methods, devices, processing, circuitry, and logic described above may be implemented in many different ways and in many different combinations of hardware and software. For example, all or parts of the implementations may be circuitry that includes an instruction processor or controller, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when performed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when performed by the circuitry.

In some examples, each unit, subunit, and/or module of the system may include a logical component. Each logical component may be hardware or a combination of hardware and software. For example, each logical component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each logical component may include memory hardware, such as a portion of the memory, for example, that includes instructions executable with the processor or other processors to implement one or more of the features of the logical components. When any one of the logical components includes the portion of the memory that includes instructions executable with the processor, the logical component may or may not include the processor. In some examples, each logical component may just be the portion of the memory or other physical memory that includes instructions executable with the processor or other processor to implement the features of the corresponding logical component without the logical component including any other hardware. Because each logical component includes at least some hardware even when the included hardware includes software, each logical component may be interchangeably referred to as a hardware logical component.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

1. A wireless communication method, comprising:
determining, by a user equipment (UE), a configuration of at least one radio bearer of the UE for transmitting a sidelink positioning protocol (SLPP) message; and
transmitting, by the UE, the SLPP message carried by the at least one radio bearer according to the configuration, wherein the at least one radio bearer comprises at least one of a data radio bearer (DRB) or an signaling radio bearer (SRB).

2. The method of claim 1, wherein the SRB is exclusively for carrying the SLPP message.

3. The method of claim 2, further comprising:
determining, by the UE, a logical channel identity (LCID) dedicated for the SRB.

4. The method of claim 2, wherein the configuration of at least one radio bearer comprises a cast type indication of the SLPP message from a NAS layer of the UE to a AS layer of the UE.

5. The method of claim 4, wherein the cast type indication indicates at least one of unicast, groupcast, or broadcast.

6. The method of claim 2, further comprising:
transmitting, by the UE, the SLPP message carried by the SRB according to the configuration, wherein the configuration comprises a predefined cast type of the SRB.

7. The method of claim 2, further comprising:
transmitting, by the UE, the SLPP message carried by two SRBs according to the configuration, wherein the configuration comprises a predefined cast type of each of the two SRBs,
the predefined cast type of one SRB within the two SRBs is at least one of broadcast or groupcast, and
the predefined cast type of the other SRB within the two SRBs is unicast.

8. The method of claim 1, wherein the at least one SRB corresponding to the at least one radio bearer is at least one of SL-SRB0, SL-SRB1, SL-SRB2, SL-SRB3 or SL-SRB4.

9. The method of claim 8, further comprising:
transmitting, by an AS layer of the UE to a NAS layer of the UE, a first indication to indicate whether the at least one SRB is used to transmit the SLPP message.

10. The method of claim 9, wherein the first indication is indicated in a sidelink control channel configuration.

11. The method of claim 1, wherein each of the at least one SRB corresponding to each of the at least one radio bearer has different SRB type.

12. The method of claim 1, wherein the radio bearer comprises the at least one DRB and the configuration comprises a second indication to indicate whether the at least one DRB contains the SLPP message.

13. The method of claim 1, wherein the radio bearer comprises the at least one DRB and the configuration comprises a third indication to indicate whether a QoS flow corresponding to the DRB contains the SLPP message.

14. The method of claim 1, wherein the radio bearer comprises the at least one DRB and the configuration comprises a forth indication to indicate a priority of the DRB.

15. The method of claim 1, wherein the radio bearer comprises the at least one DRB and the configuration comprises a QoS flow-to-DRB mapping rule of a QoS flow that contains the SLPP message.

16. The method of claim 1, wherein the configuration comprises a priority of a logical channel of the DRB or a priority of a QoS flow of the SLPP message, wherein the priority of the logical channel of the DRB or the priority of the QoS flow of the SLPP message is of a highest priority.

17. A wireless communication method, comprising:
obtaining, by a user equipment (UE), a MAC PDU carrying a sidelink positioning protocol (SLPP) message; and
filtering, by a MAC layer of the UE, the MAC PDU based on two different pre-defined conditions to determine whether to send the MAC PDU to a disassembly and demultiplexing entity.

18. The method of claim 17, wherein filtering the MAC PDU comprises determining at least one of the following two predefined conditions:
a DST field of a decoded MAC PDU subheader is equal to 8 MSB of any of Destination Layer-2 ID(s) of the UE, wherein 16 LSB of the Destination Layer-2 ID(s) of the UE are equal to a Destination ID in a corresponding SCI sidelink control information (SCI); or
a DST field of a decoded MAC PDU subheader is equal to 8 MSB of any of Source Layer-2 ID(s) of the UE, wherein 16 LSB of the Source Layer-2 ID(s) of the UE are equal to a Destination ID in a corresponding SCI, and a SRC field of the decoded MAC PDU subheader is equal to 16 MSB of any of the Destination Layer-2 ID(s) of the UE, wherein 8 LSB of the Destination Layer-2 ID(s) of the UE are equal to a Source ID in a corresponding SCI.

19. The method of claims 17 or 18, further comprising sending the MAC PDU to the disassembly and demultiplexing entity when either one of the predefined conditions is met.

20. A wireless communication apparatus, comprising:
a memory operable to store computer-readable instructions; and
a processor circuitry operable to read the computer-readable instructions, the processor circuitry when executing the computer-readable instructions is configured to:
determine a configuration of at least one radio bearer of a user equipment (UE) for transmitting a sidelink positioning protocol (SLPP) message; and
transmit the SLPP message carried by the at least one radio bearer according to the configuration, wherein the at least one radio bearer comprises at least one of a data radio bearer (DRB) or an signaling radio bearer (SRB).

21. (canceled)
